(19) United States
(12) Patent Application Publication
(10) Pub. No.: US 2020/0048564 A1
(43) Pub. Date: Feb. 13, 2020

(54) METHOD FOR SEPARATING BASIC-SEDIMENT AND WATER FROM OIL IN A CRUDE-OIL SAMPLE

(71) Applicant: Jaysun Gillingham, Calgary (CA)

(72) Inventor: Jaysun Gillingham, Calgary (CA)

(21) Appl. No.: 16/058,767

(22) Filed: Aug. 8, 2018

(51) Int. Cl. C10G 33/08; G01F 19/00; G01F 23/292; G01F 25/00

(52) U.S. Cl. CPC C10G 33/08; G01F 19/00; C10G 2300/208; G01F 25/0084; G01F 23/2928

(57) ABSTRACT

A method for separating basic-sediment and water (BS&W) from oil in an oil field crude-oil sample using a halogen lighting-unit and a sample-measurement container; the method includes obtaining a crude-oil sample having an undetermined concentration of basic-sediment, water and oil. Providing a sample-measurement container having a known volume. Inserting the crude-oil sample into the sample-measurement container, the crude-oil sample occupying the known-volume of the sample-measurement container. Exposing the crude-oil sample in the sample-measurement container to a halogen lighting-unit. Separating the basic-sediment and the water from the oil in the crude-oil in the sample-measurement container. Calculating the fraction-of-oil by volume in the crude-oil sample after the basic-sediment and the water has separated. The method for separating basic-sediment and water (BS&W) from oil in an oil field crude-oil sample using a halogen lighting unit and a sample-measurement container is useful for field tests of crude-oil samples.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of testing means for crude-oil of existing art and more specifically relates to separating basic sediment and water from oil.

### RELATED ART

In the oil industry oil is taken from the ground to be processed. Oil directly from the well source is in a raw state, and called crude-oil. The crude-oil is a contaminated version of the oil that the industry utilizes. Crude-oil is composed of various impurities, these impurities are termed basic sediment and water (BS&W). Basic sediment and water contaminations are a result of the source and extraction process. Excessive levels of any such contaminated yields an unusable product. Oil companies need to know an estimated yield from oil wells. The volume of crude-oil does not give indications on the quality of the extracted crude-oil. Oil field workers must frequently test the grade of oil in a crude-oil sample. This process generally involves acquiring a sample of crude-oil from a well and transporting the sample to a location for processing. Often the processing is performed with the use of expensive equipment. Very few field test apparatuses exist for crude-oil. A suitable solution is desired.

U.S. Pat. No. 4,938,876 to Ernest O. Ohsol relates to a method for separating oil and water emulsions. The described method for separating oil and water emulsions includes a process and apparatus for separating oil water and solids from emulsions. More particularly, the present invention provides a process and apparatus for continuously separating oil, water and solids from stable mixtures thereof, comprising heating the mixture to at least about 115° C., rapidly cooling the mixture to below 100° C., separating the solids from the liquids and separating the water from the oil. Preferably, the invention also includes the step of adding a flocculant prior to cooling the mixture.

### SUMMARY OF THE INVENTION

In view of the foregoing disadvantages inherent in the known separating basic sediment and water from oil art, the present disclosure provides a novel method for separating basic-sediment and water from oil in a crude-oil sample. The general purpose of the present disclosure, which will be described subsequently in greater detail, is to provide an efficient and effective method for separating basic-sediment and water from oil in a crude-oil sample.

According to an embodiment, a method for separating basic-sediment and water (BS&W) from oil in an oil-field crude-oil sample using a halogen lighting-unit and a sample-measurement container is also disclosed herein. The method for separating basic-sediment and water (BS&W) from oil in an oil-field crude-oil sample using a halogen lighting-unit and a sample-measurement container includes obtaining a crude-oil sample comprising an undetermined concentration of basic sediment, water and oil. Next, providing a sample measurement container having a known volume; inserting the crude-oil sample into the sample measurement container, the crude-oil sample occupying the known volume of the sample measurement container. Next, exposing the crude-oil sample in the sample measurement container to a halogen lighting unit. Then, separating the basic sediment and the water from the oil in the crude-oil in the sample measurement container. Next, calculating the fraction of oil by volume in the crude-oil sample after the basic sediment and the water has separated.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a method for separating basic-sediment and water from oil in a crude-oil sample, constructed and operative according to the teachings of the present disclosure.

FIG. 1 is a perspective view of use of the method for separating basic-sediment and water (BS&W) from oil in an oil-field crude-oil sample using a halogen lighting-unit and a sample-measurement container during an ‘in-use’ condition, according to an embodiment of the disclosure.

FIG. 2 is a perspective view of use of the method for separating basic-sediment and water (BS&W) from oil in an oil-field crude-oil sample using a halogen lighting-unit and a sample-measurement container of FIG. 1, according to an embodiment of the present disclosure.

FIG. 3 is a partial view of use of the method for separating basic-sediment and water (BS&W) from oil in an oil-field crude-oil sample using a halogen lighting-unit and a sample-measurement container of FIG. 1, according to an embodiment of the present disclosure.

FIG. 4 is a partial view of use of the method for separating basic-sediment and water (BS&W) from oil in an oil-field crude-oil sample using a halogen lighting-unit and a sample-measurement container of FIG. 1, according to an embodiment of the present disclosure.

FIG. 5 is a flow diagram illustrating a method for field testing of crude-oil, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to separating basic sediment and water from oil and more particularly to a method for separating basic-sediment and water from oil in a crude-oil sample as used to improve the field testing of crude-oil.

Generally, a method is disclosed herein for separating basic sediment and water from oil in a crude-oil sample which first involves obtaining a crude-oil sample comprising an undetermined concentration of basic sediment, water and oil. The crude-oil sample may include at least one component that is in a semi-frozen state when obtained. The crude-oil sample may alternatively be in an aqueous-state when obtained. A sample-measurement container is required, where the sample measurement container has a known volume. The sample measurement container may have gradient measurement indicia to quantitatively indicate volume of the crude-oil sample. The sample measurement container may be made from a transparent material such as glass. The sample measurement container may comprise of a light-weight material such that a user can portably carry the sample measurement container in one hand for field testing of crude-oil.

Crude-oil is then inserted into the sample measurement container, where the crude-oil occupies a known volume of the sample measurement container. The sample of crude-oil in the sample measurement container is then exposed to a halogen lighting unit. The time that the sample of crude-oil is exposed to the halogen lighting unit may be twenty minutes or until the basic sediment and the water has separated from the oil. The halogen lighting unit may produce radiant energy in the form of heat. The heat produced by the lighting unit may be of sufficient intensity to increase the viscosity of the crude-oil sample. Basic-sediment and water is then separated from the oil due to their differing specific gravities. The crude-oil sample may be agitated by tapping on the sample measurement container to induce a mechanical wave to propagate through the crude-oil sample in the sample measurement container. The mechanical wave may expedite the separation of the basic-sediment and the water from the oil. Once separated the basic sediment and the water from the oil in the crude-oil sample may define a first volume and a second volume, the first volume comprising the basic sediment and the water, the second volume comprising the oil. The fraction of oil by volume may be calculated by dividing the known volume by the second volume, the fraction of oil by volume indicating the portion of the oil in the crude-oil sample.

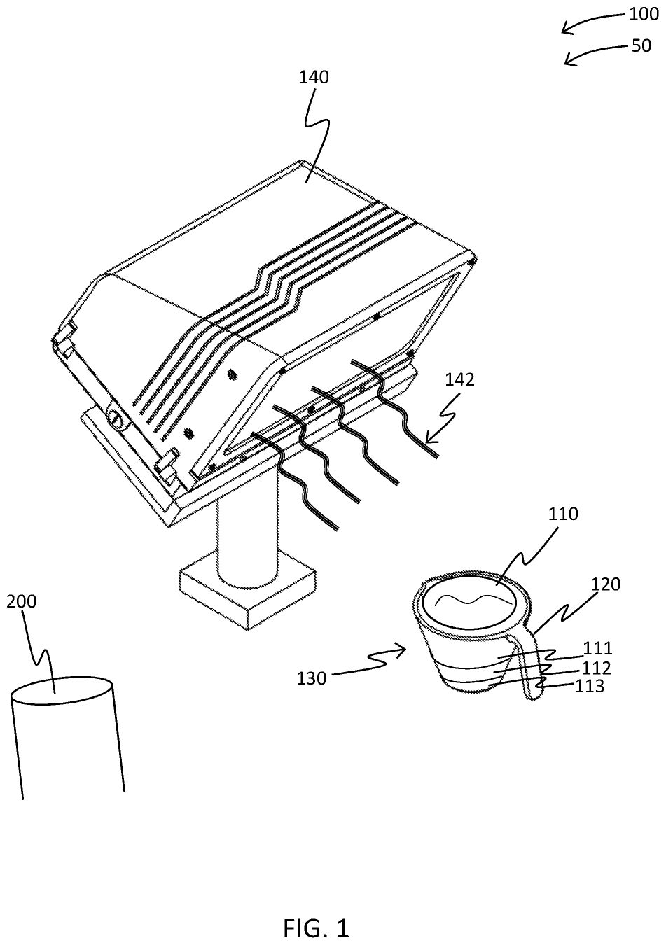

Referring now more specifically to the drawings by numerals of reference, there is shown in FIGS. 1-4, various views of use of a method 100.

FIG. 1 shows a method 100 during an ‘in-use’ condition 50, according to an embodiment of the present disclosure. Here, the method 100 may be beneficial for use by a user 40 to separate crude-oil 110. As illustrated, the method 100 may include obtaining a crude-oil 110 sample comprising an undetermined concentration of basic-sediment 111, water 112 and oil 113. The crude-oil 110 sample may be obtained of the surface from the well 200. The crude-oil 110 sample may include at least one component that is a semi-frozen state when obtained. The crude-oil 110 sample may be in an aqueous-state when obtained. A sample-measurement container 120 is provided having a known-volume 130. The crude-oil 110 sample is then inserted into the sample-measurement container 120, where the crude-oil 110 sample occupies a known-volume 130. The crude-oil 110 sample within the sample-measurement container 120 is exposed to a halogen lighting-unit 140. The crude-oil 110 may be exposed to the halogen lighting-unit 140 for twenty minutes or until the basic-sediment 111 and water 112 is separated from the oil 113. The halogen lighting-unit 140 produces radiant energy 142 in the form of heat. The heat produced from the lighting-unit 140 is of an intensity sufficient to increase the viscosity of the crude-oil 110 sample.

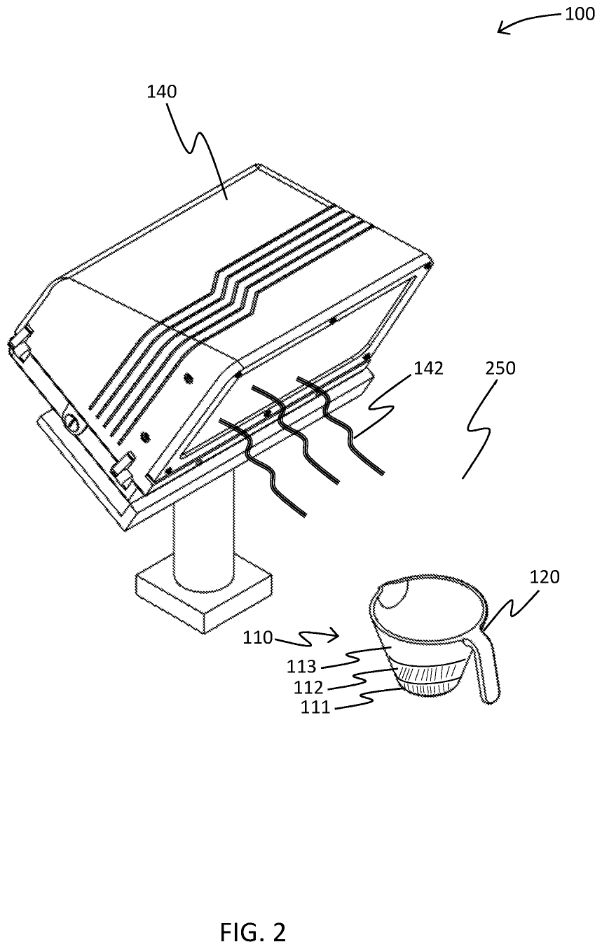

FIG. 2 shows use of the method 100 of FIG. 1, according to an embodiment of the present disclosure. As above, the method 100 may include a crude-oil 110 sample in a sample-measurement container 120. The crude-oil 110 sample is exposed to a halogen lighting-unit 140 that may project radiant energy 142. The radiant energy 142 projected from the halogen lighting-unit 140 separates the crude-oil 110 sample into basic-sediment 111, water 112, and oil 113. The volumes obtained of the basic-sediment 111, water 112, and are used to calculate a fraction-of-oil 250 of the crude-oil 110 sample.

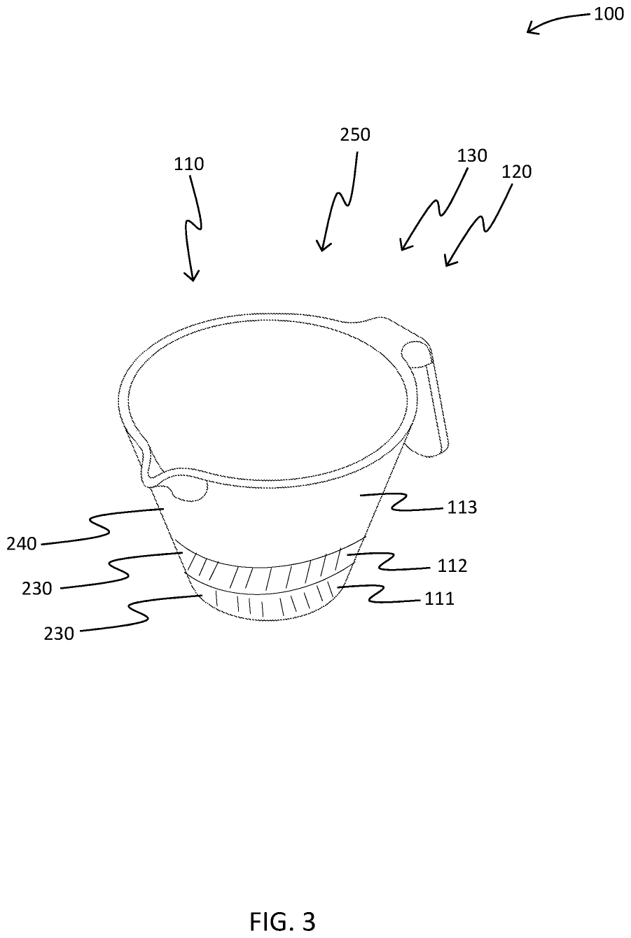

FIG. 3 is another view of using the method 100 for separating basic-sediment and water (BS&W) from oil in an oil-field crude-oil sample using a halogen lighting-unit and a sample-measurement container of FIG. 1, according to an embodiment of the present disclosure. As shown, a known-volume 130 of a crude-oil 110 sample has been separated in to the sample-measurement container 120 into the components of basic-sediment 111, water 112 and oil 113. The basic-sediment 111 and the water 112 defines a first-volume 230 and the oil 113 defines a second-volume 240. A fraction-of-oil 250 by volume is calculated by dividing the known-volume 250 by the second-volume 240, the fraction-of-oil 250 by volume indicating the portion of the oil in the crude-oil 110 sample.

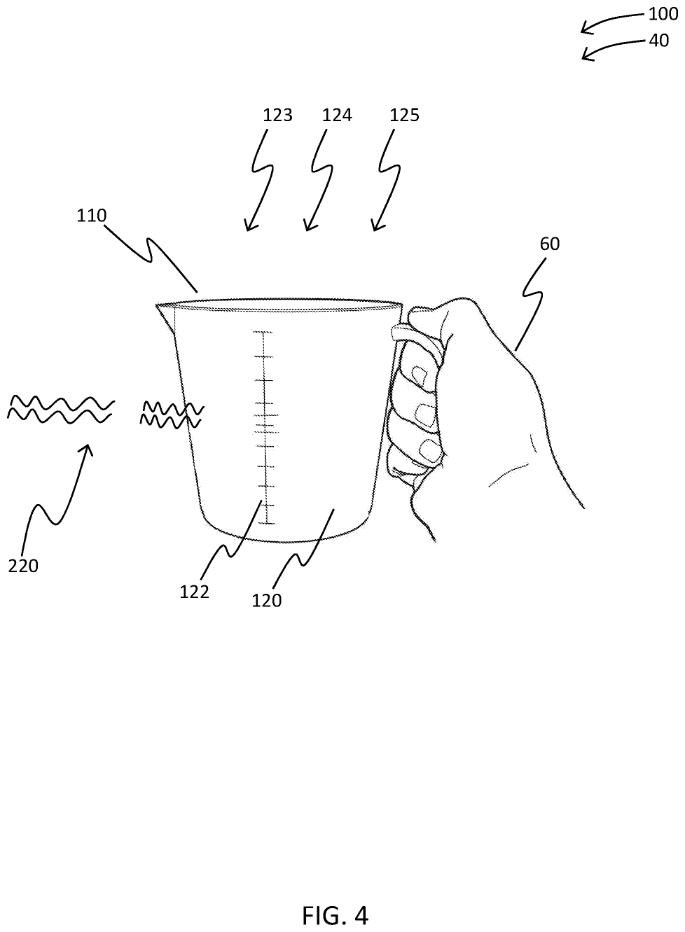

FIG. 4 is another view of use of the method 100 for separating basic-sediment and water (BS&W) from oil in an oil-field crude-oil sample using a halogen lighting-unit and a sample-measurement container 120 of FIG. 1, according to an embodiment of the present disclosure. As illustrated, the sample-measurement container 120 may have gradient measurement indicia 122. The sample-measurement container 120 may be made of a transparent material 123 such as glass 124 or a composite thereof. The sample-measurement container 120 may be made of a light-weight material 125 such that a user 40 can portably carry the sample-measurement container 120 in one hand 60. A user 40 may induce a mechanical-wave 220 to propagate through the sample-measurement container 120 to further aid separation of the crude-oil 110 sample.

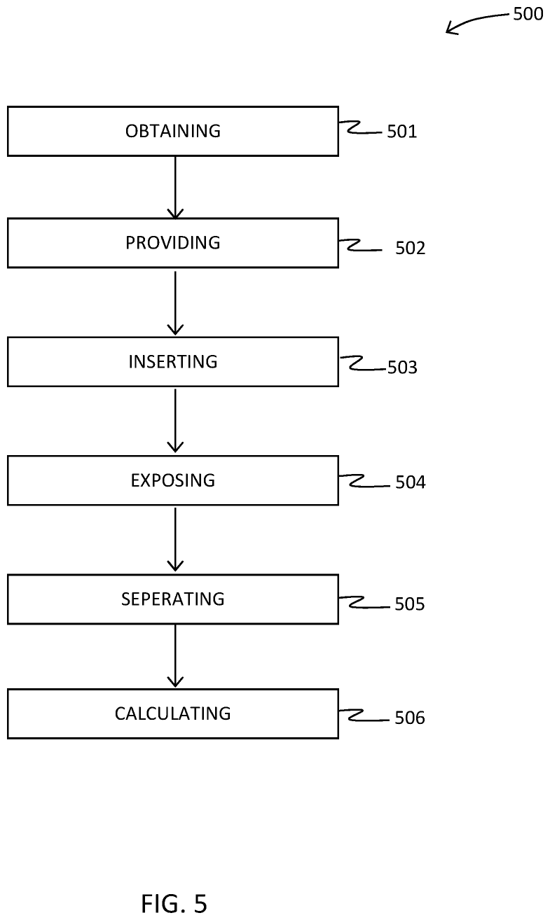

FIG. 5 is a flow diagram illustrating a method 500 for field testing of crude-oil, according to an embodiment of the present disclosure. In particular, the method for field testing of crude-oil 500 may include one or more components or features of the method 100 as described above. As illustrated, the method for separating basic sediment and water from oil in a crude-oil sample 500 may include the steps of: step one 501, obtaining a crude-oil sample 110 comprising an undetermined concentration of basic-sediment 111, water 112 and oil 113; step two 502, providing said sample-measurement container 120, the sample-measurement container 120 having a known-volume 130; step three 503, inserting the crude-oil 110 sample into the sample-measurement container 120, the crude-oil 110 sample occupying a known-volume 130 of the sample-measurement container 120; step four 504, exposing the crude-oil 110 sample in the sample-measurement container 120 to a halogen lighting-unit 140; step five 505, separating the basic-sediment 111 and the water 112 from the oil 113 in the crude-oil 110 in the sample-measurement container 120; step six 506, calculating the fraction-of-oil 250 by volume in the crude-oil 110 sample after the basic-sediment 111 and the water 112 has separated 124.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods and tools used for field testing of crude-oil, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method for separating basic-sediment and water (BS&W) from oil in an oil-field crude-oil sample using a halogen lighting-unit and a sample-measurement container, said method comprising the steps of:
obtaining a crude-oil sample comprising an undetermined concentration of basic sediment, water and oil;
providing said sample-measurement container, the sample-measurement container having a known-volume;
inserting the crude-oil sample into the sample-measurement container, the crude-oil sample occupying said known-volume of the sample-measurement container;
exposing the crude-oil sample in the sample-measurement container to a halogen lighting-unit;
separating the basic-sediment and the water from the oil in the crude-oil in the sample-measurement container;
calculating a fraction-of-oil by volume in the crude-oil sample after the basic-sediment and the water has separated;

2. The method of claim 1, wherein the crude-oil sample includes at least one component that is in a semi-frozen state when obtained.

3. The method of claim 1, wherein the crude-oil sample is obtained of a surface from the well.

4. The method of claim 1, wherein the crude-oil sample is in an aqueous-state when obtained.

5. The method of claim 1, wherein the sample-measurement container has gradient measurement indicia.

6. The method of claim 1, wherein the sample-measurement container is made from a transparent material.

7. The method of claim 1, wherein the sample-measurement container is made from a glass material.

8. The method of claim 1, wherein the sample-measurement container comprises light-weight material such that a user can portably carry the sample-measurement container in one hand.

9. The method of claim 1, wherein the crude-oil sample is exposed to the halogen lighting-unit for twenty minutes.

10. The method of claim 1, wherein the crude-oil sample is exposed to the halogen lighting-unit until the basic-sediment and the water has separated from the oil.

11. The method of claim 1, wherein the halogen lighting-unit produces radiant energy in a form of heat.

12. The method of claim 11, wherein the heat produced from the lighting-unit is of an intensity sufficient to increase the viscosity of the crude-oil sample.

13. The method of claim 1, wherein a user may induce a mechanical-wave through the crude-oil sample in the sample-measurement container, thereby aiding in the separation basic-sediment and the water from the oil.

14. The method of claim 1, wherein the separation of the basic-sediment and the water from the oil in the crude-oil sample defines a first-volume and a second-volume, the first-volume comprising the basic-sediment and the water, the second-volume comprising the oil

15. The method of claim 14, wherein a fraction-of-oil by volume is calculated by dividing the known-volume by the second-volume, the fraction-of-oil by volume indicating the portion of the oil in the crude-oil sample.

16. A method for separating basic-sediment and water from oil in an oil-field crude-oil sample using a halogen lighting-unit and a sample-measurement container, the method comprising:
obtaining a crude-oil sample comprising an undetermined concentration of basic-sediment, water and oil;
providing said sample-measurement container, the sample-measurement container having a known-volume;
inserting the crude-oil sample into the sample-measurement container, the crude-oil sample occupying said known-volume of the sample-measurement container;
exposing the crude-oil sample in the sample-measurement container to a halogen lighting-unit;
separating the basic-sediment and the water from the oil in the crude-oil in the sample-measurement container;
calculating the fraction-of-oil by volume in the crude-oil sample after the basic-sediment and the water has separated;
wherein the crude-oil sample includes at least one component that is in a semi-frozen state when obtained;
wherein the crude-oil sample is obtained of a surface from the well;
wherein the crude-oil sample is in an aqueous-state when obtained;
wherein the sample-measurement container has gradient measurement indicia;
wherein the sample-measurement container is made from a transparent material;
wherein the sample-measurement container is made from a glass material;
wherein the sample-measurement container comprises light-weight material such that a user can portably carry the sample-measurement container in one hand;
wherein the crude-oil sample is exposed to the halogen lighting-unit for twenty minutes;
wherein the crude-oil sample is exposed to the halogen lighting-unit until the basic-sediment and the water has separated from the oil;
wherein the halogen lighting-unit produces radiant energy in a form of heat;
wherein the heat produced from the lighting-unit is of an intensity sufficient to increase the viscosity of the crude-oil sample;
wherein the user induces a mechanical-wave through the crude-oil sample in the sample-measurement container, thereby aiding in the separation basic-sediment and the water from the oil;
wherein the separation of the basic-sediment and the water from the oil in the crude-oil sample defines a first-volume and a second-volume, the first-volume comprising the basic-sediment and the water, the second-volume comprising the oil; and
wherein a fraction-of-oil by volume is calculated by dividing the known-volume by the second-volume, the fraction-of-oil by volume indicating the portion of the oil in the crude-oil sample.
